(19) United States
(12) Patent Application Publication
(10) Pub. No.: US 2018/0129350 A1
(43) Pub. Date: May 10, 2018

(54) EQUALIZER FOR TOUCHSCREEN SIGNAL PROCESSING

(71) Applicant: QUALCOMM Incorporated, San Diego, CA (US)

(72) Inventor: Yibo JIANG, Beijing (CN)

(21) Appl. No.: 15/576,634

(22) PCT Filed: May 13, 2016
(86) PCT No.: PCT/CN2016/081964

§ 371 Date: Nov. 22, 2017

(30) Foreign Application Priority Data
May 15, 2015 (CN) PCT/CN2015/079120

(51) Int. Cl. G06F 3/041; G06F 3/044

(52) U.S. Cl. CPC G06F 3/0418; G06F 2203/04101; G06F 3/044

(57) ABSTRACT

Systems and techniques are presented for detecting touch inputs on a touch screen with improved accuracy. Raw sensor readings are received from a plurality of proximity sensors that detect an external object to the touch screen. An equalization is applied to the raw sensor readings. The equalization takes into account an equalization profile indicative of one or more responses from one or more proximity sensors to a reference object positioned in known proximity to the touch screen. Equalized sensor readings are generated based on applying the equalization to the raw sensor readings and positional data is generated based on the equalized sensor readings.

### BACKGROUND

### 1. The Field of the Invention

The present invention generally relates to touch screens. More specifically, the present invention relates to detecting inputs on a touch screen with improved accuracy.

### 2. The Relevant Technology

Touch screens can be used in computing devices to combine functionalities of a display screen with an input device. A touch screen can provide a compact form factor that can be beneficial for use in mobile devices, such as smart phones and tablets. Even for computing devices with larger form factors, touch screens can provide an intuitive and interactive/customizable interface when compared to traditional input devices, such as keyboards, mice, track pads, etc. However, touch screens can have varying degrees of accuracy when detecting touch screen inputs, especially when multiple objects/digits are used to provide a command to a touch screen. The position of an input, as well as a number of input contact points, are often misinterpreted. Thus, there is need for improvement in the fiend of touch screen detection.

### BRIEF SUMMARY

Systems are presented for detecting touch inputs on a touch screen with improved accuracy. In one configuration a system comprises an equalizer unit configured to receive raw sensor readings from a plurality of touch sensors that detect contact between an external object and the touch screen, and apply equalization to the raw sensor readings. The equalization taking into account a response characterizing a channel, the channel including effects of the touch screen and the plurality of touch sensors on the raw sensor readings. The equalizer unit further generates equalized sensor readings based on applying the equalization to the raw sensor readings, and transmits the equalized sensor readings to a detector unit. The detector unit is configured to receive the equalized sensor readings from the equalizer unit, and generate positional data based on the equalized sensor readings, the positional data indicating a horizontal coordinate and a vertical coordinate of the contact on the touch screen.

Methods for detecting touch inputs on a touch screen with improved accuracy are presented. In one configuration the method comprises receiving raw sensor readings from a plurality of touch sensors that detect contact between an external object and the touch screen and applying equalization to the raw sensor readings. The equalization takes into account a response characterizing a channel, the channel including effects of the touch screen and the plurality of touch sensors on the raw sensor readings. The method further comprises generating equalized sensor readings based on applying the equalization to the raw sensor readings and generating positional data based on the equalized sensor readings, the positional data indicating a horizontal coordinate and a vertical coordinate of the contact on the touch screen.

Apparatuses for detecting touch inputs on a touch screen with improved accuracy are presented. In one configuration the apparatus comprises a means for receiving raw sensor readings from a plurality of touch sensors that detect contact between an external object and the touch screen. The apparatus also comprises a means for applying equalization to the raw sensor readings. The equalization takes into account a response characterizing a channel, the channel including effects of the touch screen and the plurality of touch sensors on the raw sensor readings. The apparatus also comprises a means for generating equalized sensor readings based on applying the equalization to the raw sensor readings and a means for generating positional data based on the equalized sensor readings, the positional data indicating a horizontal coordinate and a vertical coordinate of the contact on the touch screen.

Non-transitory computer-readable media are presented which contain stored instructions, which when executed cause a computer to perform a set of operations. The operations comprise receiving raw sensor readings from a plurality of touch sensors that detect contact between an external object and the touch screen and applying equalization to the raw sensor readings. The equalization takes into account a response characterizing a channel, the channel including effects of the touch screen and the plurality of touch sensors on the raw sensor readings. The operations further comprise generating equalized sensor readings based on applying the equalization to the raw sensor readings and generating positional data based on the equalized sensor readings, the positional data indicating a horizontal coordinate and a vertical coordinate of the contact on the touch screen.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is an illustration of one embodiment of a touch screen including touch sensors for detecting proximity.

FIGS. 2A and 2B are illustrations of another embodiment of a touch screen including proximity sensors and example readings generated by the touch sensors.

FIGS. 3A-3D are illustrations of example signals corresponding to inputs detected by proximity sensors.

FIG. 4 is a block diagram of one embodiment of a system for detecting inputs on a touch screen with improved accuracy.

FIGS. 5A and 5B are block diagrams of different embodiments of systems for detecting touch inputs on a touch screen with improved accuracy.

FIG. 6 is a flowchart of one embodiment of a process for detecting inputs on a touch screen with improved accuracy.

FIG. 7 is an example logical diagram of a system for modeling one or more channels according to certain embodiments.

FIG. 8 is a table comparing test results generated by detection based on raw sensor inputs and test results generated by detection based on equalized sensor inputs.

FIG. 9 is a flowchart of one embodiment of a process for determining the equalization to be used in detecting touch inputs on a touch screen with improved accuracy.

FIG. 10 is an embodiment of a special-purpose computer system and a computing device that can be used to implement a system for detecting touch inputs on a touch screen with improved accuracy.

FIG. 11 is an example computer system for use in implementing features of certain embodiments.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims. Further, when a particular feature, structure, or characteristic is described in connection with an embodiment, it is submitted that it is within the knowledge of one skilled in the art to implement such feature, structure, or characteristic in connection with other embodiments whether or not explicitly described.

The accuracy of a touch screen can have a significant impact on the quality of user experience when interacting with the touch screen. Accuracy can refer to a detected position of a contact point in relation to the actual position of the contact point or a detected number of contact points in relation to an actual number of contact points. For example, when a user's finger (or other digit) makes are in proximity to a touch screen, sensors of the touch screen can detect the proximity and generate signals or readings that can be used to determine the position of the finger on the touch screen. As another example, when a user provides two or more fingers in proximity to a touch screen, sensors of the touch screen can detect the two or more fingers as a singular finger input, especially if the two or more fingers are in close proximity. Due to factors and variations in channels of detection of the finger(s), the signals or readings do not always accurately reflect the actual position of the finger(s) in relation to the touch screen. For example, due to a transfer of pressure to surrounding areas of a touch screen when the touch screen is depressed by a finger, sensors can generate readings that indicate contact in a larger area than the actual contact area of the finger with the touch screen. If rigidity of the screen is not uniform across the screen (e.g., more rigid around the edges than the center of the screen), the detected area can be larger on one side of the actual contact area than another, which can cause a different position to be detected other than the actual contact position. Additionally, if two or more points of contact are near each other, readings from the sensors can be interpreted as a single point of contact at a position between the two actual points of contact.

Embodiments described herein are directed toward improving accuracy in the detection of touch inputs on a touch screen by modeling the touch screen as a linear system. In one embodiment, an impulse response is determined for the touch screen. The impulse response can be determined by measuring known inputs in a controlled environment or through adaptive learning techniques. An equalization can be determined based on the impulse response and the equalization can be applied to further raw touch sensor readings to generate equalized sensor readings. Based on the equalized sensor readings, a more accurate position of the touch inputs can be determined. Although many examples and embodiments provided herein are described in the context of distinguishing between two touch inputs that are near each other, it is understood that embodiments are not so limited. Rather, the concepts described herein may be implemented to improve all aspects of accuracy for detecting touch inputs, including improving the accuracy of detecting the position of a single touch input or more than two touch inputs.

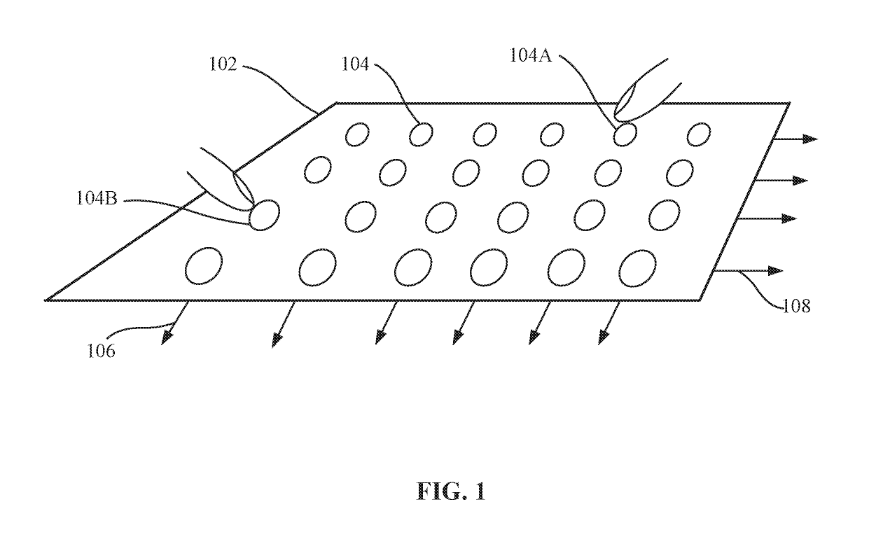

FIG. 1 is an illustration of one embodiment of a touch screen 102. The embodiment illustrated in this figure is a self capacitance touch screen 102 that includes vertical sensor lines 106 (not all labeled for sake of clarity) and horizontal sensor lines 108 (not all labeled for sake of clarity). By combining the readings from the vertical sensor lines 106 with the readings from the horizontal sensor lines 108, a matrix or grid of specific contact points 104 (not all labeled for sake of clarity) can be detected. As illustrated in this figure, fingers are making contact with the touch screen 102 at contact points 104A and 104B. By further processing the readings from sensor lines 106 and 108, a finger position can be detected even when the finger is touching the screen 102 between contact points 104. For example, interpolation can be performed on the readings from sensor lines 106 and 108 to determine positions that are not directly on one of the contact points 104.

In certain embodiments, vertical sensor lines 106 and/or horizontal sensor lines 108 can be multiplexed and/or driven concurrently (in whole or in part). Depending on the touch screen driving schema, it may be difficult to accurately detect finger contacts in proximity with the touch screen. For example, a multiplexed driving and corresponding detecting schema can be used where each of vertical sensor lines 106 and horizontal sensor lines 108 are sequentially driven within a frame. The frame can be a period of time wherein an entire touch screen can be driven and/or sensed to detect all contact points present on the touch screen for the frame.

If a sequential/multiplexed row and column schema is used, it may be difficult to detect multiple contact points. For example, two touches at notional horizontal and vertical coordinates respectfully can be (X1, Y1) and (X2, Y2). The resulting sensor readings could be (X1, X2, Y1, Y2). Therefore, it may be difficult to ascertain where the two contact points lie, or if there have been only two contact points. In other words, the readings (X1, X2, Y1, Y2) could correspond to any number of access points anywhere on the horizontal sensors corresponding to (X1, X2) or the vertical sensors corresponding to (Y1, Y2).

Furthermore, as disclosed herein, a singular contact point can affect proximity sensor readings in an area surrounding and including the contact point's contact area with a touch screen. Depending on a correlation between a touch screen's rigidity, a density of proximity sensors, and the type of proximity sensor schema used, a single contact point can be detected via a plurality of sensors. As will be further discussed, the response of a singular contact inducing a response in a plurality of sensors can make determination of an accurate location of an input difficult.

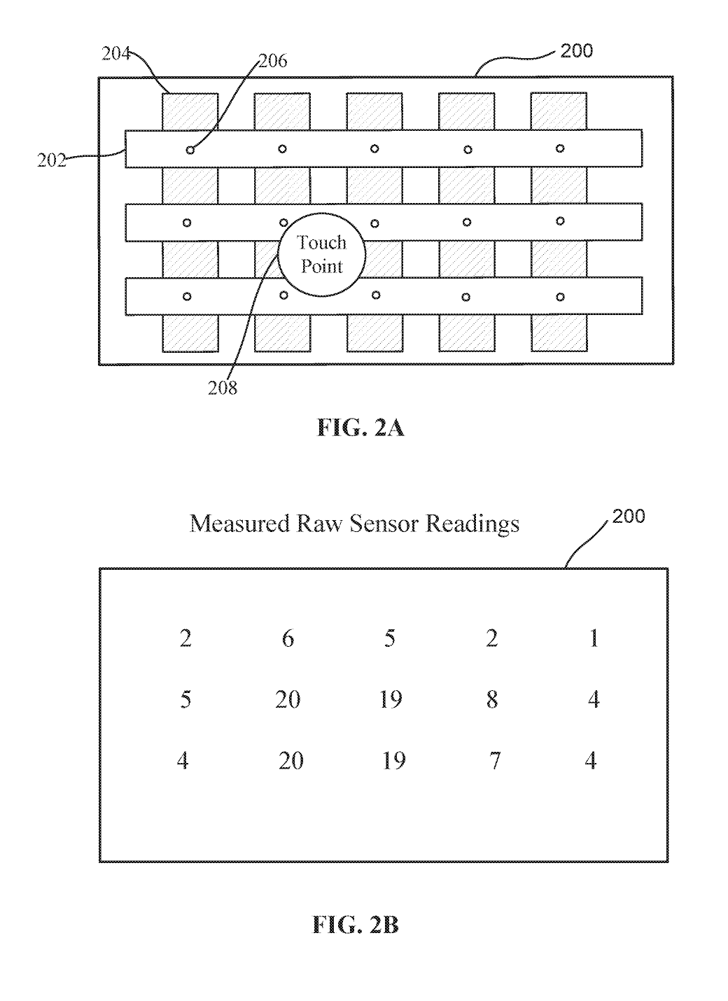

FIG. 2A is an illustration of another embodiment of a touch screen 200 including touch sensor lines 202. The embodiment illustrated in FIG. 2A is a mutual capacitance touch screen 200 that only has horizontal sensor lines 202 (not all labeled for sake of clarity). Each vertical drive line 204 (not all labeled for sake of clarity) is used to transmit a drive signal, which can be a voltage that is applied to drive lines 204. The drive signal is sequentially applied to one of drive lines 204 at a time and, based on the readings from sensor lines 202, the position of contact point 208 can be determined. FIG. 2B illustrates example readings generated by interpreting signals of sensor lines 202 from a frame, which is a period of time during which the drive signal has been sequentially applied to each drive line 204. As illustrated in this figure, the highest readings correspond to the position of touch point 208, and the readings decrease in value at positions that move away from touch point 208.

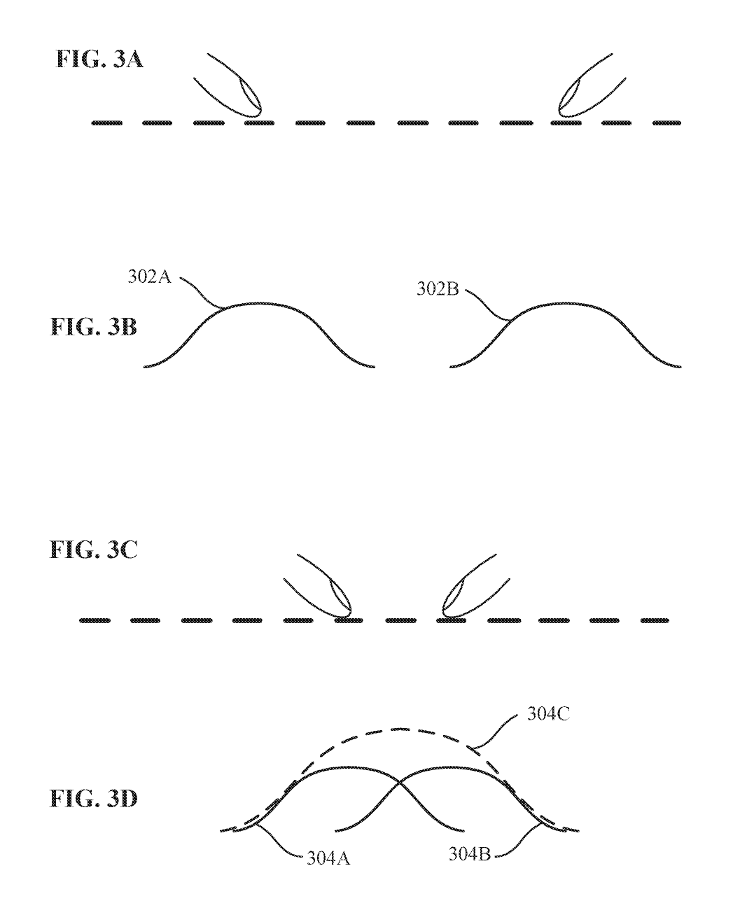

FIGS. 3A-3D are illustrations of example signals corresponding to touches detected by touch sensors. The signals 302A and 302B illustrated in FIG. 3B are generated by interpolating sensor readings corresponding to touch positions illustrated in FIG. 3A. The signals 302A-302C illustrated in FIG. 3D are generated by interpolating sensor readings corresponding to touch positions illustrated in FIG. 3C. As can be seen in FIG. 3B, two distinct waves are generated when the fingers are far apart from each other, and two distinct touch inputs can be detected by, for example, detecting the peaks of signals 302A and 302B. However, when the fingers are close together, as illustrated in FIG. 3C, the interpolated signals 304A and 304B can be too close to distinguish two separate touch inputs, or interpolation can cause the generation of signal 304C from the touch readings and only a single touch input will be detected.

Signal 304C can be a superposition and/or other interpolation of signals 304A and 304B influenced by the physical design of a touch screen, imperfections in manufacturing of a touch screen, a sensor schema, a combination of the preceding, or other. For example, the sensing schema may be designed to take into account manufacturing imperfections that can exist when manufacturing a touch screen that effect the response of each sensor, driver, sensor and/or drive line used on a touch screen. These imperfections can take the form of noise that can reduce the accuracy of a position measurement. Furthermore, the design of the screen itself may influence the accuracy of the detected signal. For example, a central portion of a screen may be more rigid than edges of the screen. However, a detection schema may or may not take such considerations into account. As one example, The detection schema may assign a worst case tolerance to readings detected for a position of an input. The tolerance can account for physical constraints, manufacturing constraints, or other imperfections described herein that can introduce noise on a channel when attempting to determine a position of a touch point, such as touch point 208. These tolerance values can contribute to inaccuracy of touch point position determination when interpreting sensor readings.

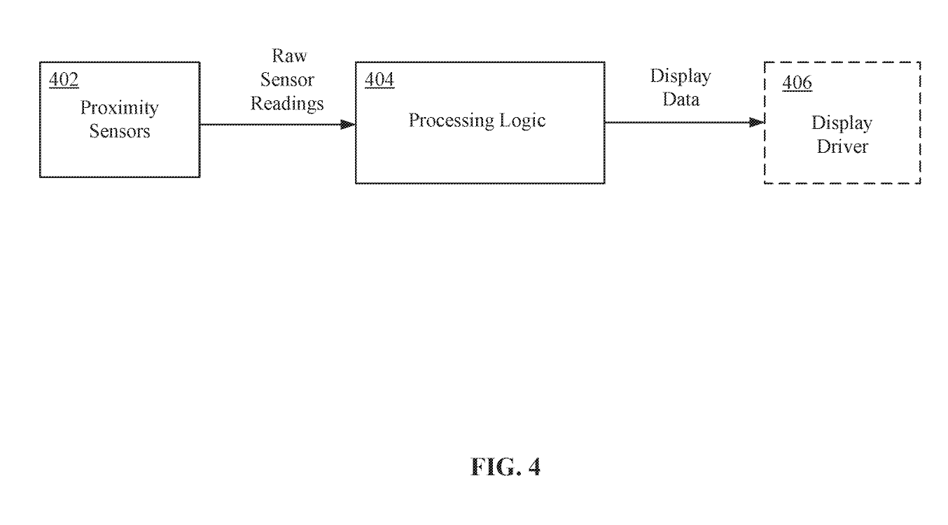

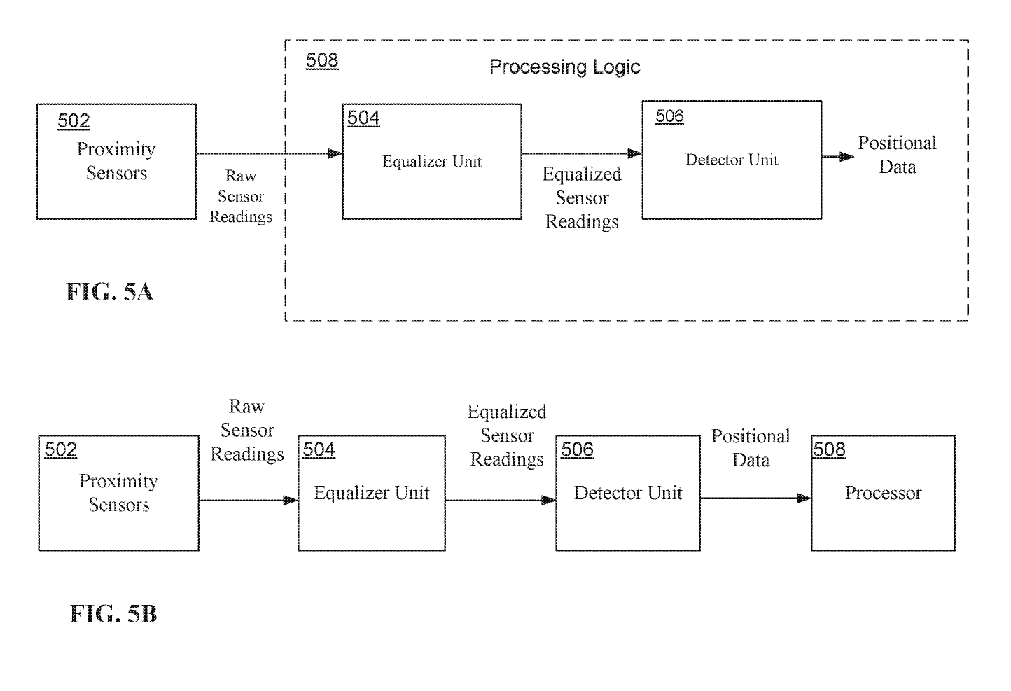

FIG. 4 is a block diagram of one embodiment of a system for detecting touch inputs on a touch screen with improved accuracy. This high level diagram illustrates the basic components of the system, while more detailed views of the system are illustrated in FIGS. 5A and 5B. In this embodiment, the system includes proximity sensors 402 (capacitive sensors, ultrasound sensors, optical sensors, or other), processing logic 404, and display driver 406. Proximity sensors 402 detect touch inputs on the touch screen and generate raw sensor readings. The raw sensor readings are fed from proximity sensors 402 into processing logic 404, where the readings are processed to generate positional data that indicate coordinates of inputs. Software programs such as an operating system and an application can then use the positional data to respond to the touch inputs. The display data can be fed to display driver 406, which can then cause a touch screen to generate corresponding graphics and/or displays. However, a display of a touch screen-enabled device does not necessarily have to be modified through detection of an input to the touch screen. For example, an audio alert from a speaker of the device may be commanded to activate or the device powered off, for example.

FIGS. 5A and 5B are block diagrams of different embodiments of systems for detecting proximity inputs on a touch screen. Either embodiment includes proximity sensors 502, equalizer unit 504, detector unit 506, and processing logic 508. The difference between the two embodiments is that equalizer unit 504 and detector unit 506 can be implemented as software modules executed by processing logic 508 in the embodiment illustrated in FIG. 5A, while the units 504 and 506 can be implemented as one or more separate hardware processing units in the embodiment illustrated in FIG. 5B. For example, equalizer unit 504 and detector unit 506 can be implemented as a single application specific integrated circuit, or each unit 504 and 506 can be implemented as a separate Application Specific Integrated Circuit (ASIC). Further examples of processing logic than can be used to implement functionality of any one of touch sensors 502, equalizer unit 504, detector unit 506, or processing logic 508 include Field Programmable Gate Arrays (FPGAs), x86 or ARM® compatible processor cores, logic gates, a combination of any of the preceding (including an ASIC), or other.

In both embodiments, raw sensor readings from touch sensors 502 can be received by equalizer unit 504. Equalizer unit 504 can apply equalization to the raw sensor readings to generate equalized sensor readings. The equalization can take into account a response that characterizes one or more channels. The equalization unit can use an equalization profile when performing equalization. As used herein, the term “channel” means a path along which information in the form of an electrical signal passes. A channel can include effects of the touch screen and the touch sensors 502 on the raw sensor readings. For example, manufacturing imperfections, physical constraints of the touch screen, environmental noise, noise generated by other channels, or other can effect a specific raw sensor reading determined using a channel of a touch screen device. The equalized sensor readings can then be transmitted to the detector unit 506 for the detector unit 506 to generate positional data based on the equalized sensor readings. For example, generating positional data can include interpolating the equalized sensor readings and to detect positions of one or more touch inputs. The positional data can then be used by processing logic 508 as input for applications.

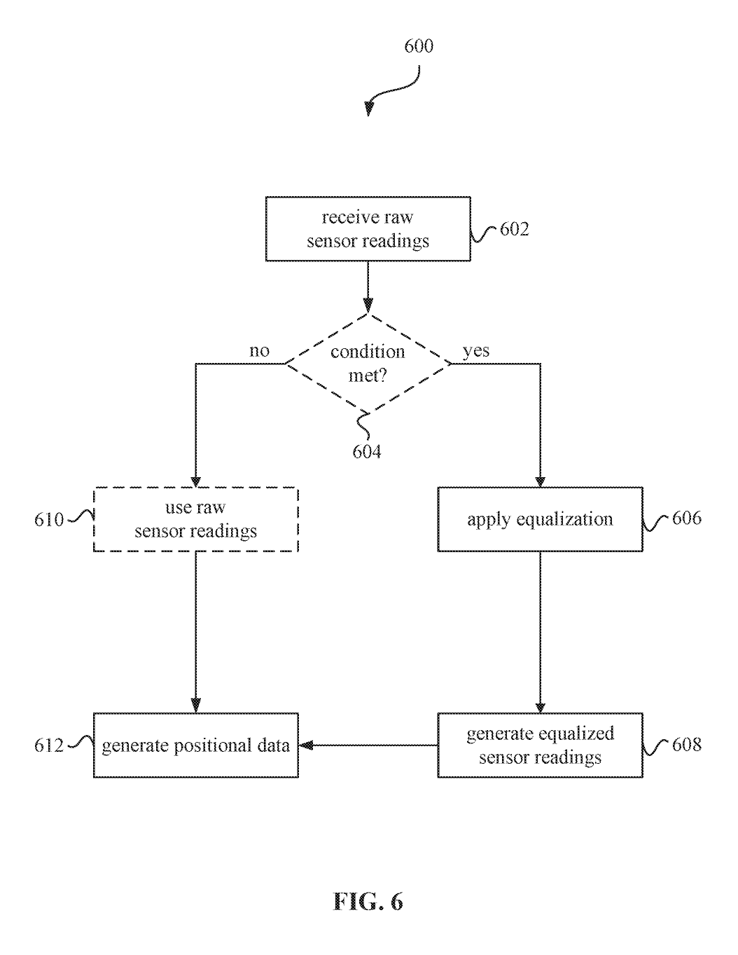

FIG. 6 is a flowchart of one embodiment of a process 600 for detecting touch inputs on a touch screen with improved accuracy. In this embodiment, process 600 starts at block 602 with the receiving of raw sensor readings. Optional block 604 can be performed to determine if one or more conditions are met. If a condition is met, process 600 can continue through blocks 606 and 608 and the positional data generated in block 612 can be based on equalized sensor readings. However, if the condition is not met, process 600 can continue to block 610 and the positional data can be generated based on the raw sensor readings. There can be multiple conditions that must be met before equalization is applied. If the raw sensor readings indicate unfavorable operating condition for applying equalization, equalization will not be applied to save processing power and conserve energy. In an example embodiment, the signal to noise (SNR) ratio of the raw sensor readings can be compared with a threshold value. If the SNR ratio is greater than or equal to the threshold value, the process can continue to block 606. The SNR ratio can be determined by detected a nominal signal level when a device is idle (e.g., no input is being applied to a touch screen) and comparing the nominal signal level to a signal detected when a user is operating the device via the touch screen.

Various other examples of conditions can include an estimated area of a screen that the raw sensor readings indicate that an input is detected. For example, an edge area of a touch screen display can be less rigid than a central area and therefore more prone to noise due to inducement of flex or deformation of the screen due to contact by a user input. Furthermore, an amount of equalization can be determined by the conditions that are met. As one example, applying an equalization to the raw sensor readings can utilize more power than not applying the equalization or applying less equalization. The determination can take several conditions into account when determining if or how much equalization to apply.

Further examples of conditions can include an environment of the device. For example, a device implementing the disclosed touch screen can determine if the device is in an environment of defined temperature, humidity, or other variables that may affect channel(s) of the device when attempting to determine a position of an input applied to a touch screen. As another example, an amount of electromagnetic interference can be used as a condition or an absolute location of a device determined via Global Positioning System (GPS) or other means. Another condition may be an orientation of the device. For example, a device placed in landscape mode may be effected differently than a device in landscape mode. These environmental variables can be detected by an environmental sensor coupled to a mobile device, for example. Otherwise environmental information can be determined by a mobile device by receiving environmental information from an external source, such as a weather information server.

Still further examples of conditions can be a level of charge of a battery of a device. For example, if a battery is nearing depletion, it may be more desirable not to apply equalization. Furthermore, a charge level of a device can indicate a voltage level and therefore a level of accuracy that a sensor can detect a position of an input. Likewise, a condition can be if the device is plugged into an outlet for operational power and/or for charging of a battery. Still other conditions can be a time from which the device was last calibrated/manufactured. As a device ages, sensors and/or its physical structure may degrade and provide less sensitive, precise, or accurate sensor readings. Therefore, equalization may be more beneficial to maintain touch screen performance for devices as they age (and/or a level of equalization increased over time).

Conditions can also be dictated depending on one or more rules of the device. For example, a rule can dictate that more or less equalization be applied for certain applications. For example, some applications may benefit from more precise and accurate readings from a touch screen. Such applications can include word processing or other applications. Still other applications may require less accurate readings, such as a game. One or more rules can be utilized to select an appropriate equalization level for a running application, an application mode, a request for touch screen input, an anticipation of touch screen input, or other.

At block 606, equalization can be applied to the raw signal values. One method for modeling touch screens (such as touch screens 102 and 200) is to model the touch screens as antennas and communication systems. For example, the various sensor and/or drive lines (such as 106, 108, 202, and 204) can be modeled as antennas. Drivers to generate drive signals and Receivers for detecting modifications to the drive signal or corresponding received signals can be modeled as communication transmitters and receivers, respectively. The sensor and/or drive lines can then be modeled as channels through which the various drive and reception signals are transmitted.

Furthermore, each touch screen can be modeling as containing a plurality of drivers, a plurality of receivers, and a plurality of transmission channels. A response to an output of each driver can then be modeled as effecting one or more receivers with corresponding gains for each channel. Furthermore, random, or other, noise can be taken into account for example received signal through each channel.

For example, if the touch screen is modeled as a linear system with an impulse response given by [h_{L-1} h_{L-2} . . . h₁ h₀ h₁ . . . h_{L-2} h_{L-1}]. The system can be modeled by Y=H*X+n, where Y=[y₁ . . . yᵣ₋₁ yᵣ] is the raw touch readings for a particular row or column of the touch screen, X=[x₁ . . . xᵣ₋₁ xᵣ] is the actual, known position of the touch input to be estimated, n is a noise vector (such as Gaussian or other noise), and H is a channel matrix that represents channel effects on the underlying position of the touch input. The channel matrix H can have the Toeplitz structure as follows, with h_{L} on the diagonal:

$$H = [ \begin{matrix}{h}_{0} & {h}_{1} & … & {h}_{L - 1} & 0 & 0 & … & 0 \\ {h}_{1} & {h}_{0} & … & {h}_{L - 2} & {h}_{L - 1} & 0 & … & 0 \\ ⋱ & ⋱ & ⋱ & ⋱ & ⋱ & ⋱ & ⋱ & \\ 0 & … & 0 & {h}_{L - 1} & {h}_{L - 2} & … & {h}_{1} & {h}_{0}\end{matrix} ]$$

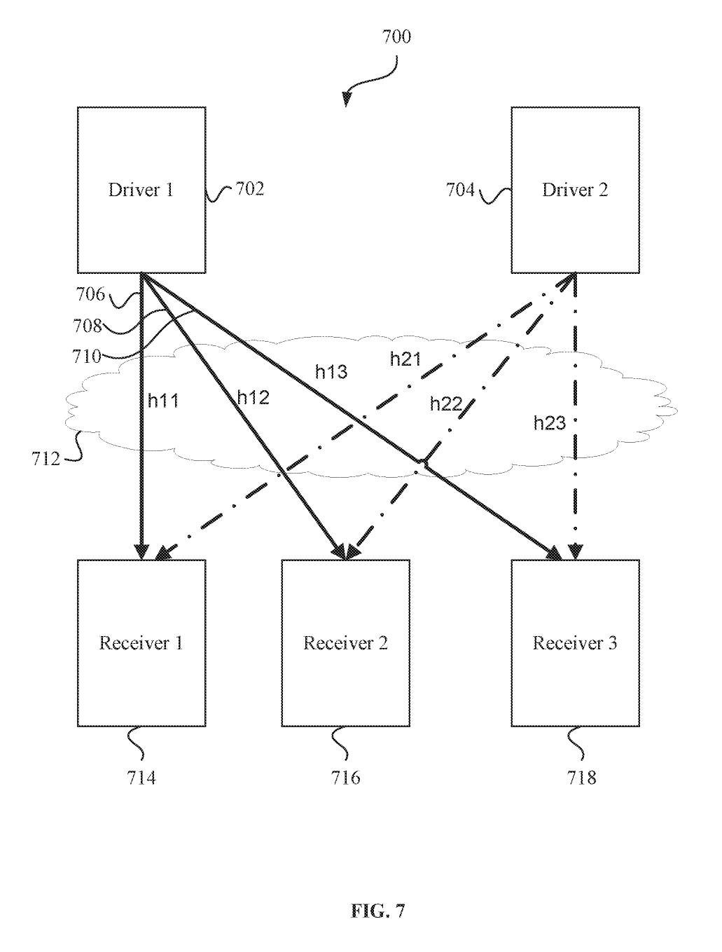

FIG. 7 will now be referenced in order to illustrate the methodology behind the techniques disclosed for block 606. FIG. 7 includes a system 700 that can be used to model a touch screen of a device. System 700 includes a first driver 702 and a second driver 704. Furthermore, system 700 includes a first receiver 714, a second receiver 716, and a third receiver 718. First driver 702 and/or second driver 704 can correspond to driving circuits for rows or columns of a touch screen for sending proximity of an object, such as touch screens 102 or 200, for example. Receivers 714, 716, and 718 can likewise be associated with columns or rows of a touch screen. Drivers 702 and 704 and receivers 714, 716, and 718 can share similar logic or be implemented as a single device. For example, a driver/receiver can be implemented as a transducer or similar device with a driving mode and a reception mode. Such modes can be implemented in a time ordered manner to detect a reflection of a driven signal.

System 700 also includes channels 706, 708, and 710 indicating signal paths between driver 702 and receivers 714, 716, and 718 respectively. Each of channels 706, 708, and 710 can be effected by non-random noise from the structure or other features of the mobile device, as disclosed herein. Cloud 712 symbolizes the effect of this noise as it can effect each of the channels differently. For example, a specific model of touch screen may be designed with some touch sensor (or drivers/receivers) in close location to a power source that induces an offset on those lines. Certain channels may traverse a physically longer path through a mobile device touch screen and may therefore be subject to relatively higher signal degradation. Some physical areas of a touch screen may be more flexible than others leading to addition degradation. Furthermore, a state of the mobile device (such as folded or flexed) can effect channel parameters.

The various values of h11, h12, h13, h21, h22, and h23 can be gain values assign to each channel to offset the various effects induced on the channels by the physical configuration of the device. In this example, h11 is a gain value associated with channel 706 between driver 802 and receiver 714. The gain value can be a value greater than, less than, or equal to one. In this manner, each channel in a device can be calibrated for various conditions. Each of these gain values can be included in matrix H. Although this one example for modeling of gain values, various other models can be used as well. For example, certain gain values can be adjusted depending upon a variable. As another example, a gain value for a channel can be modeled by a function or other technique. As yet another example, some gain values can be static and others can be variable. In some embodiments, various equalization profiles can be applied having different gain values and/or gain functions applied depending upon one or more conditions of the mobile device. A same channel can have multiple gain values assigned depending upon the specific equalization profile applied.

For the example techniques provided for block 606, the equalization can be a block equalizer given by H⁻¹. A block equalizer can equalize all values of y. An estimate, Xₑₛₜ, for X can be calculated by Xₑₛₜ=H⁻¹y. In other embodiments, other equalizations can be applied to the raw sensor readings, such as a maximum likelihood equalizer. A maximum likelihood equalizer can be implemented to estimate X using Xₑₛₜ=argmaxₓ Pr(Y=y|x)=argminₓ|y−Hx|², where argmax and argmin are argument maximum and argument minimum functions respectively, Pr(P1=P2|C) is a probability function of P1 equaling P2 given C.

Based on applying the equalization to the raw sensor readings, equalized sensor readings are generated at block 608. Positional data is then generated based on the equalized sensor readings at block 612. For example, positional data can be generated by detecting peaks or maximums in the equalized sensor readings, or interpolating the equalized sensor readings and then detecting peaks or maximums in the interpolated signal, to detect positions of one or more touch inputs and distinguish between multiple touch inputs on the touch screen.

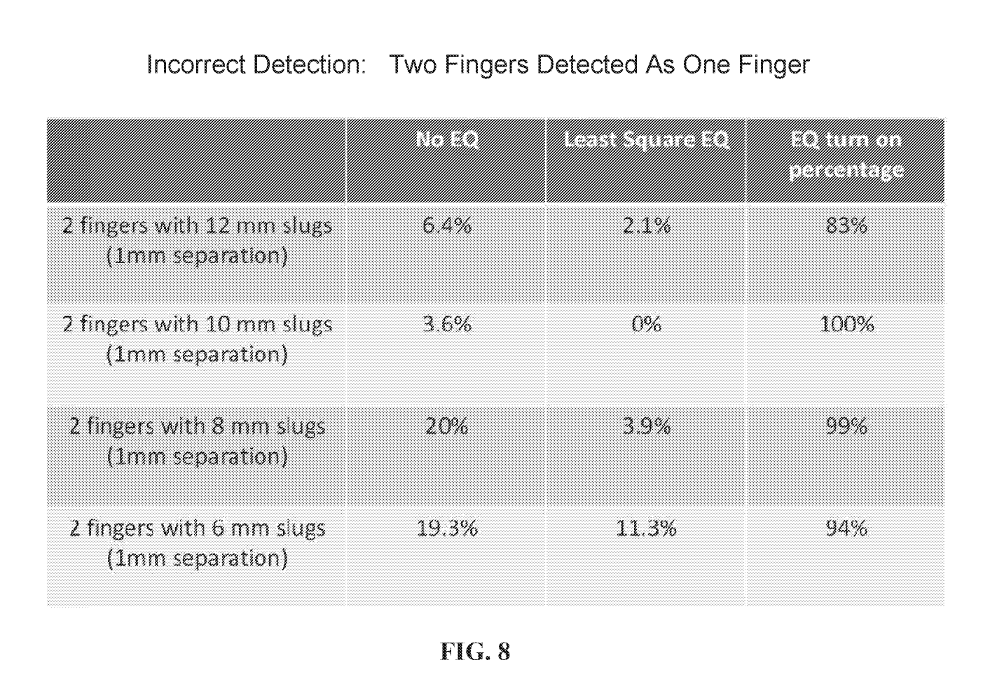

FIG. 8 is a table comparing test results generated by detection based on raw sensor inputs and test results generated by detection based on equalized sensor inputs. Different sized test slugs having round, cylindrical shapes were used to simulate fingers of different sizes. The tests were performed with two slugs at 1 millimeter separation on a touch screen and the results indicate whether a single touch input was detected or two touch inputs were detected. Specifically, the first column (“No EQ”) of the results indicate the percentage of times that the two slugs were detected as a single touch input without applying equalization, the second column (“Least Square EQ”) indicates the percentage of times that the two slugs were detected as a single touch input with equalization being applied conditionally, and the last column (“EQ turn on percentage”) indicates the percentage of times that certain conditions were met such that equalization was applied. As can be seen in the results, the system that applied equalization had less incorrect detections for every size of slugs used in the test.

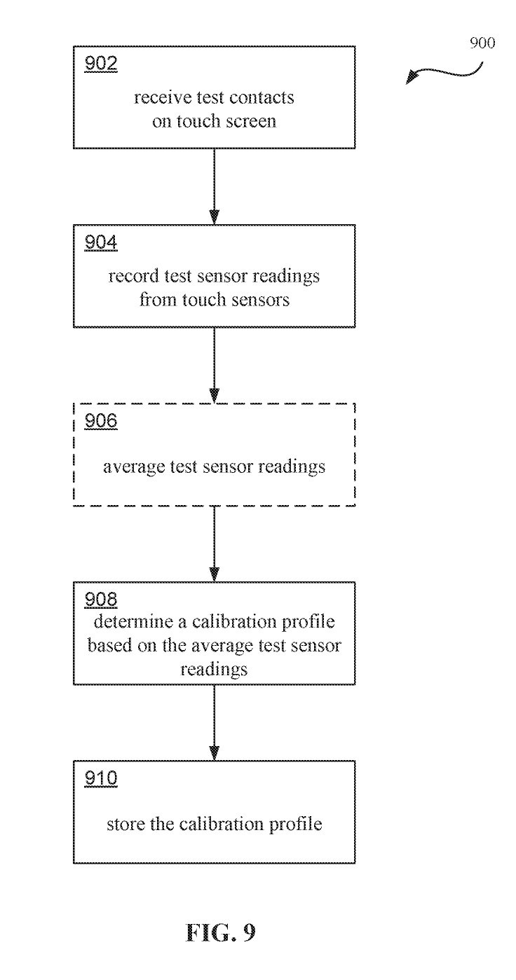

FIG. 9 is a flowchart of one embodiment of a process 900 for determining the equalization to be used in detecting touch inputs on a touch screen with improved accuracy. This process can be performed for different types of touch screens and touch sensors, different models of devices, or different manufacturers of touch screens to determine an equalization for each type/model/manufacturer.

At block 902, physical test contacts can be applied to a touch screen of a device and detected by the device. The test contacts can be applied in a test environment, for example by a robot using a stylus with a very small and exact tip, where the specific position of the contact relative to the touch screen is known. Alternatively, the test contacts can be applied by a user, for example, following calibration instructions that indicate to the user where to press. At block 904, raw sensor readings from the touch sensors corresponding to the applied test contacts are recorded and at optional block 906, an average of the test readings can be determined. The average can be treated as a touch sensor response vector and can be dependent on the sensor's location on the touch screen. At block 908, an equalization profile can be determined. The equalization profile can include matrix H disclosed including gains of various channels that are associated with a touch screen. The equalization profile can be saved internally to a device or can be provided to a server for distribution to a device as needed.

Process 900 can be conducted under various conditions. For example, process 900 can be conducted for a certain model of touch screen and/or associated controller circuitry. When a change is made to the touch screen, it's physical components, the controller circuitry, or other, the process 900 can be repeated to determine and store a new equalization profile. Process 900 can be conducted multiple times to store a plurality of profiles for a singular device. For example, process 900 can be performed for a singular device under various temperature, humidity, pressure, or other conditions. Process 900 can be performed for various states of a device such as if the device is oriented in different directions, a keyboard of the device is retracted, a device is flexed in a certain orientation, or other. A device can then store multiple profiles that can be selected based on one or more conditions (such as for decision point 604). If a server contains the profiles, it can source an appropriate profile to a device depending on detected conditions or locations of devices.

Responses to the various test sensor readings can be aggregated to determine one or more equalization profiles. An equalization profile can be a block profile that includes various gains or other information to apply to multiple sensor channels. In other words, responses can be detected from impulse responses provided by a test stimulus at various locations on a touch screen that can be aggregated or averaged to determine average gain or other values for a specific channel over various conditions. Alternatively, various values can be associated to various channels depending on various conditions that can be determined by a device. As another example, a plurality of equalization profiles can be used to equalize a touch screen or a model of touch screen. For example, an equalization profile can be assigned to a specific area of a touch screen. At 910, an equalization profile can be stored to a device or server.

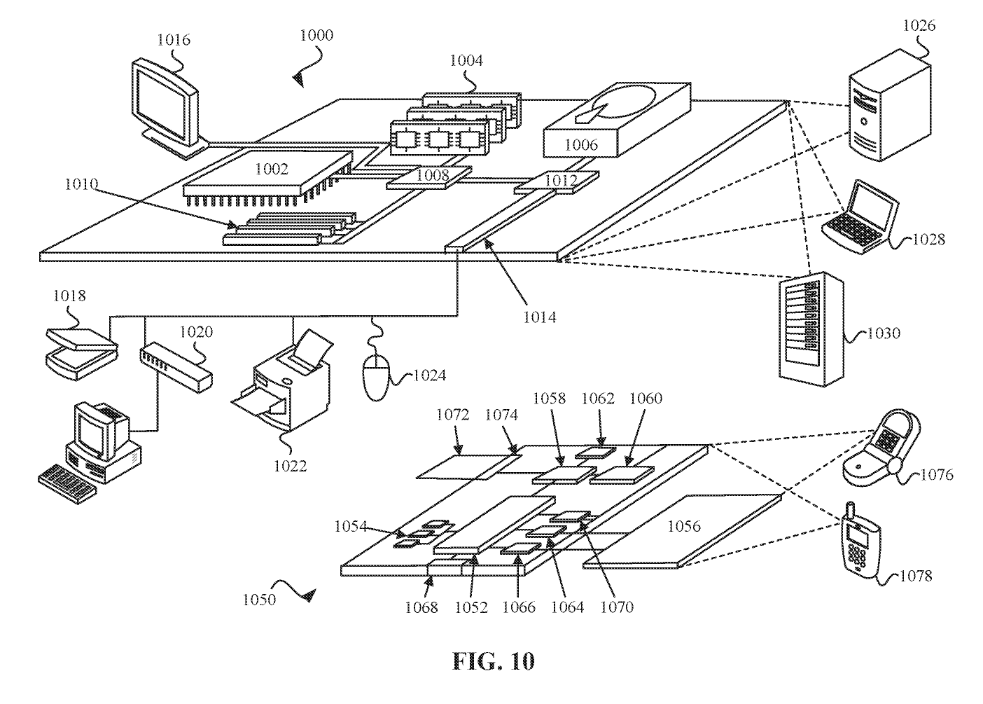

FIG. 10 is an illustration of embodiments of a special-purpose computer system 1000 and a computing device 1050 that can be used to implement a system for displaying information customized for a ticket of a fare gate. Special-purpose computer system 1000 represents various forms of digital computers, such as laptops, desktops, workstations, personal digital assistants, servers, blade servers, mainframes, and other appropriate computers. Computing device 1050 represents various forms of mobile devices, such as personal digital assistants, cellular telephones, smart phones, tablets, laptops and other similar computing devices.

Computer system 1000 includes a processor 1002, random access memory (RAM) 1004, a storage device 1006, a high speed controller 1008 connecting to RAM 1004 and high speed expansion ports 1010, and a low speed controller 1012 connecting to storage device 1006 and low speed expansion port 1014. The components 1002, 1004, 1006, 1008, 1010, 1012, and 1014 are interconnected using various busses, and may be mounted on a common motherboard or in other manners as appropriate. Computer system 1000 can further include a number of peripheral devices, such as display 1016 coupled to high speed controller 1008. Additional peripheral devices can be coupled to low speed expansion port 1014 and can include an optical scanner 1018, a network interface 1020 for networking with other computers, a printer 1022, and input device 1024 which can be, for example, a mouse, keyboard, track ball, or touch screen.

Processor 1002 processes instructions for execution, including instructions stored in RAM 1004 or on storage device 1006. In other implementations, multiple processors and/or multiple busses may be used, as appropriate, along with multiple memories and types of memory. RAM 1004 and storage device 1006 are examples of non-transitory computer-readable media configured to store data such as a computer program product containing instructions that, when executed, cause processor 1002 to perform methods and processes according to the embodiments described herein. RAM 1004 and storage device 1006 can be implemented as a floppy disk device, a hard disk device, an optical disk device, a tape device, a flash memory or other similar solid-state memory device, or an array of devices, including devices in a storage area network or other configurations.

High speed controller 1008 manages bandwidth-intensive operations for computer system 1000, while low speed controller 1012 manages lower bandwidth-intensive operations. Such allocation of duties is exemplary only. In one embodiment, high speed controller 1008 is coupled to memory 1004, display 1016 (e.g., through a graphics processor or accelerator), and to high speed expansion ports 1010, which can accept various expansion cards (not shown). In the embodiment, low speed controller 1012 is coupled to storage device 1006 and low speed expansion port 1014. Low speed expansion port 1014 can include various communication ports or network interfaces, such as universal serial bus (USB), Bluetooth, Ethernet, and wireless Ethernet.

Computer system 1000 can be implemented in a number of different forms. For example, it can be implemented as a standard server 1026, or multiple servers in a cluster. It can also be implemented as a personal computer 1028 or as part of a rack server system 1030. Alternatively, components from computer system 1000 can be combined with other components in a mobile device (not shown), such as device 1050. Each of such devices can contain one or more of computer system 1000 or computing device 1050, and an entire system can be made up of multiple computer systems 1000 and computing devices 1050 communicating with each other.

Computing device 1050 includes a processor 1052, memory 1054, an input/output device such as a display 1056, a communication interface 1058, and a transceiver 1060, among other components. The components 1052, 1054, 1056, 1058, and 1060 are interconnected using various busses, and several of the components may be mounted on a common motherboard or in other manners as appropriate. Computing device 1050 can also include one or more sensors, such as GPS or A-GPS receiver module 1062, cameras (not shown), and inertial sensors including accelerometers (not shown), gyroscopes (not shown), and/or magnetometers (not shown) configured to detect or sense motion or position of computing device 1050.

Processor 1052 can communicate with a user through control interface 1064 and display interface 1066 coupled to display 1056. Display 1056 can be, for example, a thin-film transistor (TFT) liquid-crystal display (LCD), an organic light-emitting diode (OLED) display, or other appropriate display technology. Display interface 1066 can comprise appropriate circuitry for driving display 1056 to present graphical and other information to the user. Control interface 1064 can receive commands from the user and convert the commands for submission to processor 1052. In addition, an external interface 1068 can be in communication with processor 1052 to provide near area communication with other devices. External interface 1068 can be, for example, a wired communication interface, such as a dock or USB, or a wireless communication interface, such as Bluetooth or near field communication (NFC).

Device 1050 can also communicate audibly with the user through audio codec 1070, which can receive spoken information and convert it to digital data that can be processed by processor 1052. Audio codec 1070 can likewise generate audible sound for the user, such as through a speaker. Such sound can include sound from voice telephone calls, recorded sound (e.g., voice messages, music files, etc.), and sound generated by applications operating on device 1050.

Expansion memory 1072 can be connected to device 1050 through expansion interface 1074. Expansion memory 1072 can provide extra storage space for device 1050, which can be used to store applications or other information for device 1050. Specifically, expansion memory 1072 can include instructions to carry out or supplement the processes described herein. Expansion memory 1072 can also be used to store secure information.

Computing device 1050 can be implemented in a number of different forms. For example, it can be implemented as a cellular telephone 1076, smart phone 1078, personal digital assistant, tablet, laptop, or other similar mobile device.

It is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

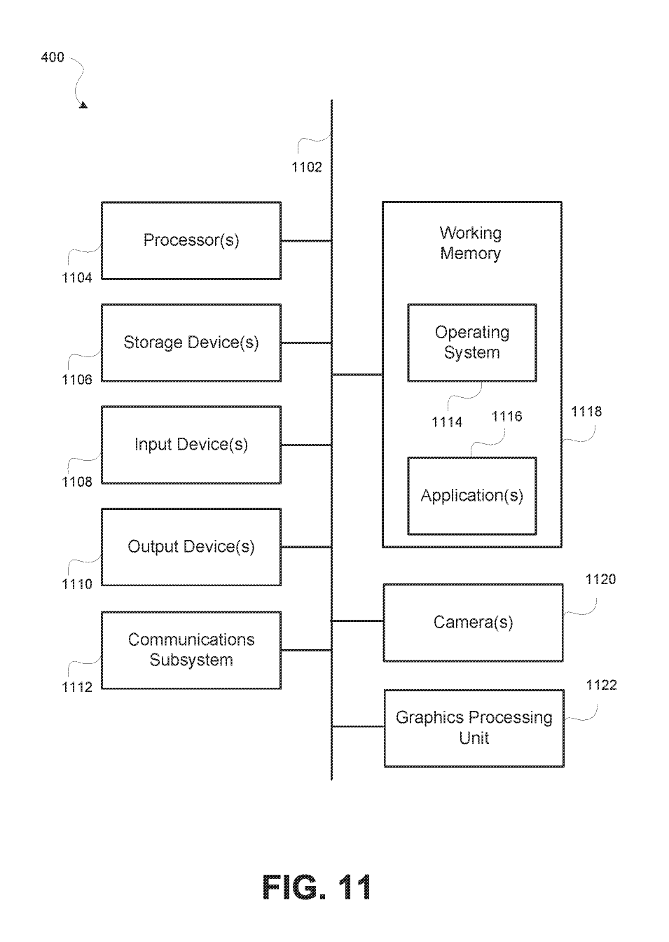

FIG. 11 as an illustration of an example computer system that may incorporate features of certain embodiments. For example, computer system 1100 can represent some of the components of a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 11 provides a schematic illustration of one implementation of a computer system 1100 that can perform the methods provided by various other implementations, as described herein, and/or can function as the host computer system, a remote kiosk/terminal, a point-of-sale device, a telephonic or navigation or multimedia interface in an automobile, a computing device, a set-top box, a table computer and/or a computer system. FIG. 11 is meant only to provide a generalized illustration of various components, any or all of which may be utilized as appropriate. FIG. 11, therefore, broadly illustrates how individual system elements may be implemented in a relatively separated or relatively more integrated manner.

The computer system 1100 is shown comprising hardware elements that can be electrically coupled via a bus 1102 (or may otherwise be in communication, as appropriate). The hardware elements may include one or more processors 1104, including without limitation one or more general-purpose processors and/or one or more special-purpose processors (such as digital signal processing chips, graphics processing units 1122, and/or the like); one or more input devices 1108, which can include without limitation one or more cameras, sensors, a mouse, a keyboard, a microphone configured to detect ultrasound or other sounds, and/or the like; and one or more output devices 1110, which can include without limitation a display unit such as the device used in implementations of the invention, a printer and/or the like. Additional cameras 1120 may be employed for detection of user's extremities and gestures. In some implementations, input devices 1108 may include one or more sensors such as infrared, depth, and/or ultrasound sensors. The graphics processing unit 1122 may be used to carry out the method for real-time wiping and replacement of objects described above.

In some implementations of the implementations of the invention, various input devices 1108 and output devices 1110 may be embedded into interfaces such as display devices, tables, floors, walls, and window screens. Furthermore, input devices 408 and output devices 1110 coupled to the processors may form multi-dimensional tracking systems.

The computer system 1100 may further include (and/or be in communication with) one or more non-transitory storage devices 1106, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 1100 might also include a communications subsystem 1112, which can include without limitation a modem, a network card (wireless or wired), an infrared communication device, a wireless communication device and/or chipset (such as a Bluetooth device, an 802.11 device, a WiFi device, a WiMax device, cellular communication facilities, etc.), and/or the like. The communications subsystem 1112 may permit data to be exchanged with a network, other computer systems, and/or any other devices described herein. In many implementations, the computer system 1100 will further comprise a non-transitory working memory 1118, which can include a RAM or ROM device, as described above.

The computer system 1100 also can comprise software elements, shown as being currently located within the working memory 1118, including an operating system 1114, device drivers, executable libraries, and/or other code, such as one or more application programs 1116, which may comprise computer programs provided by various implementations, and/or may be designed to implement methods, and/or configure systems, provided by other implementations, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 1106 described above. In some cases, the storage medium might be incorporated within a computer system, such as computer system 1100. In other implementations, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which may be executable by the computer system 1100 and/or might take the form of source and/or installable code, which, upon compilation and/or installation on the computer system 1100 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some implementations, one or more elements of the computer system 1100 may be omitted or may be implemented separate from the illustrated system. For example, the processor 1104 and/or other elements may be implemented separate from the input device 1108. In one implementation, the processor may be configured to receive images from one or more cameras that are separately implemented.

Some implementations may employ a computer system (such as the computer system 1100) to perform methods in accordance with the disclosure. For example, some or all of the procedures of the described methods may be performed by the computer system 1100 in response to processor 1104 executing one or more sequences of one or more instructions (which might be incorporated into the operating system 1114 and/or other code, such as an application program 1116) contained in the working memory 1118. Such instructions may be read into the working memory 1118 from another computer-readable medium, such as one or more of the storage device(s) 1106. Merely by way of example, execution of the sequences of instructions contained in the working memory 1118 might cause the processor(s) 1104 to perform one or more procedures of the methods described herein.

The terms “machine-readable medium” and “computer-readable medium,” as used herein, refer to any medium that participates in providing data that causes a machine to operate in a specific fashion. In some implementations implemented using the computer system 1100, various computer-readable media might be involved in providing instructions/code to processor(s) 1104 for execution and/or might be used to store and/or carry such instructions/code (e.g., as signals). In many implementations, a computer-readable medium may be a physical and/or tangible storage medium. Such a medium may take many forms, including but not limited to, non-volatile media, volatile media, and transmission media. Non-volatile media include, for example, optical and/or magnetic disks, such as the storage device(s) 1106. Volatile media include, without limitation, dynamic memory, such as the working memory 1118. Transmission media include, without limitation, coaxial cables, copper wire and fiber optics, including the wires that comprise the bus 1102, as well as the various components of the communications subsystem 1112 (and/or the media by which the communications subsystem 1112 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 1104 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1100. These signals, which might be in the form of electromagnetic signals, acoustic signals, optical signals and/or the like, are all examples of carrier waves on which instructions can be encoded, in accordance with various implementations of the invention.

The communications subsystem 1112 (and/or components thereof) generally will receive the signals, and the bus 1102 then might carry the signals (and/or the data, instructions, etc. carried by the signals) to the working memory 1118, from which the processor(s) 1104 retrieves and executes the instructions. The instructions received by the working memory 1118 may optionally be stored on a non-transitory storage device 406 either before or after execution by the processor(s) 1104.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Moreover, nothing disclosed herein is intended to be dedicated to the public.

While some examples of methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. An apparatus for detecting touch inputs on a touch screen with improved accuracy, the apparatus comprising:
a touch screen;
a plurality of proximity sensors configured to detect an object in proximity to the touch screen;
a memory storing an equalization profile, the equalization profile indicative of one or more responses from one or more proximity sensors of the plurality of proximity sensors to a reference object positioned in known relative proximity to the touch screen;
a detector unit; and
an equalizer unit configured to:
receive raw sensor readings from the plurality of proximity sensors that detect proximity of an interacting object with the touch screen,
apply equalization to the raw sensor readings, the equalization based on the equalization profile,
generate equalized sensor readings based on applying the equalization to the raw sensor readings, and
transmit the equalized sensor readings to the detector unit; and
wherein the detector unit is configured to:
receive the equalized sensor readings from the equalizer unit, and
generate positional data based on the equalized sensor readings, the positional data indicating a location of the interacting object in proximity to the touch screen.

2. The system of claim 1, wherein the equalizer unit is further configured to determine whether a condition is met, and wherein, upon determining that the condition is met, transmitting, by the equalizer unit, the equalized sensor readings to the detector unit.

3. The system of claim 2, wherein the determining whether the condition is met includes determining whether a signal to noise ratio of the raw sensor readings meets a threshold.

4. The system of claim 1, wherein a response of the one or more responses is an impulse response to an object positioned in a known special orientation with respect to the touch screen.

5. The system of claim 1, wherein the equalization profile includes a response model including a plurality equalization values each corresponding to a respective channel, each channel coupled to a sensor of the plurality of proximity sensors.

6. The system of claim 5, wherein plurality of proximity sensors includes a proximity of capacitive sensors.

7. The system of claim 1, wherein the equalization profile is one of a plurality of equalization profiles, each equalization profile associated with one or more rules; and
the equalizer unit is further configured to determine which equalization profile of the plurality of profiles to apply based on the one or more rules and one or more conditions.

8. The system of claim 7, wherein a first condition of the one or more conditions is a determination that the raw sensor readings indicate that the interacting object is in proximity to a first area of the touch screen; and
a second condition of the one or more conditions is a determination that the raw sensor readings indicate that the interacting object is in proximity to a second area of the touch screen.

9. A method for detecting touch inputs on a touch screen with improved accuracy, the method comprising:
receiving raw sensor readings from a plurality of proximity sensors that detect contact between an external object and the touch screen;
applying equalization to the raw sensor readings, the equalization based on an equalization profile, the equalization profile indicative of one or more responses from one or more proximity sensors of the plurality of proximity sensors to a reference object positioned in known relative proximity to the touch screen;
generating equalized sensor readings based on applying the equalization to the raw sensor readings; and
generating positional data based on the equalized sensor readings, the positional data indicating a location of the interacting object in proximity to the touch screen.

10. The method of claim 9, further comprising:
receiving a test contact in proximity to the touch screen at a known position relative to the touch screen;
in response to the receiving the test contact, recording a first set of test sensor readings from the plurality of proximity sensors; and
determining the equalization profile based on the first set of test sensor readings.

11. The method of claim 10, further comprising:
receiving a second test contact in proximity to the touch screen at the known position relative to the touch screen;
recording a second set of second test sensor readings from the plurality of touch sensors; and
determining an average of the first set of test sensor readings and the second set of test sensor readings,
wherein the equalization profile is determined based on the average.

12. The method of claim 9, further comprising:
determining whether a condition is met; and
upon determining that the condition is met, applying the equalization to the raw sensor readings.

13. The method of claim 12, wherein the determining that the condition is met includes determining whether a signal to noise ratio of the raw sensor readings meets a threshold.

14. The method of claim 12, further comprising, wherein the determining that the condition is met includes determining that an environmental condition of the touch screen meets the condition, the environmental condition determined by an environmental sensor separate and distinct from the plurality of proximity sensors.

15. The method of claim 9, wherein the touch screen is a mutual capacitance touch screen.

16. An apparatus for detecting touch inputs on a touch screen with improved accuracy, the apparatus comprising:
means for receiving raw sensor readings from a plurality of proximity sensors configured to detect an object in proximity to the touch screen;
means for applying equalization to the raw sensor readings, the equalization based on an equalization profile, the equalization profile indicative of one or more responses from one or more proximity sensors of the plurality of proximity sensors to a reference object positioned in known relative proximity to the touch screen;
means for generating equalized sensor readings based on applying the equalization to the raw sensor readings; and
means for generating positional data based on the equalized sensor readings, the positional data indicating a location of the interacting object in proximity to the touch screen.

17. The apparatus of claim 16, further comprising:
means for determining whether a condition is met; and
means for, upon determining that the condition is met, applying the equalization to the raw sensor readings.

18. The apparatus of claim 17, wherein the means for determining that the condition is met comprises:
means for determining whether a signal to noise ratio of the raw sensor readings meets a threshold.

19. The apparatus of claim 16, wherein a response of the one or more responses is an impulse response to an object positioned in a known special orientation with respect to the touch screen.

20. The apparatus of claim 16, wherein the equalization profile includes a response model including a plurality equalization values each corresponding to a respective channel, each channel coupled to a sensor of the plurality of proximity sensors.

21. The apparatus of claim 20, wherein the plurality of proximity sensors includes a plurality of capacitive sensors.

22. The apparatus of claim 16, wherein the equalization profile is one of a plurality of equalization profile, each equalization profile associated with one or more rules, the determining which equalization profile of the plurality of profiles to apply is based on the one or more rules and one or more conditions.

23. The apparatus of claim 22, wherein a first condition of the one or more conditions is a determination that the raw sensor readings indicate that the interacting object is in proximity to a first area of the touch screen; and
a second condition of the one or more conditions is a determination that the raw sensor readings indicate that the interacting object is in proximity to a second area of the touch screen.

24. A non-transitory computer-readable medium, having instructions stored therein, which when executed cause a computer to perform a set of operations comprising:
receiving raw sensor readings from a plurality of proximity sensors that detect contact between an external object and the touch screen;
applying equalization to the raw sensor readings, the equalization based on an equalization profile, the equalization profile indicative of one or more responses from one or more proximity sensors of the plurality of proximity sensors to a reference object positioned in known relative proximity to the touch screen;
generating equalized sensor readings based on applying the equalization to the raw sensor readings; and
generating positional data based on the equalized sensor readings, the positional data indicating a location of the interacting object in proximity to the touch screen.

25. The non-transitory computer-readable medium of claim 24, having further instructions stored therein, which when executed cause the computer to perform a set of operations comprising:
in response to receiving a test contact in proximity to the touch screen at a known position relative to the touch screen, recording a first set of test sensor readings from the plurality of proximity sensors; and
determining the equalization profile based on the first set of test sensor readings.

26. The non-transitory computer-readable medium of claim 25, having further instructions stored therein, which when executed cause the computer to perform a set of operations comprising:
in response to receiving a test contact in proximity to the touch screen at a known position relative to the touch screen, recording a second set of test sensor readings from the plurality of proximity sensors;
determining an average of the first set of test sensor readings and the second set of test sensor readings,
wherein the equalization profile is determined based on the average.

27. The non-transitory computer-readable medium of claim 24, having further instructions stored therein, which when executed cause the computer to perform a set of operations comprising:
determining whether a condition is met; and
upon determining that the condition is met, applying the equalization to the raw sensor readings.

28. The non-transitory computer-readable medium of claim 27, wherein the determining that the condition is met includes determining whether a signal to noise ratio of the raw sensor readings meets a threshold.

29. The non-transitory computer-readable medium of claim 24, wherein the equalization profile is one of a plurality of equalization profile, each equalization profile associated with one or more rules, the one or more rules used to determine which equalization profile of the plurality of profiles to apply depending upon one or more conditions.

30. The non-transitory computer-readable medium of claim 24, wherein the touch screen is a mutual capacitance touch screen.
